(19) United States
(12) Patent Application Publication
(10) Pub. No.: US 2013/0255517 A1
(43) Pub. Date: Oct. 3, 2013

(54) Solvent-Based Inkjet-Printed Negatives for Making Flexo Plates

(71) Applicants: John P. Maneira, Alpharetta, GA (US); Krasimir G. Chobadzhiev, Alpharetta, GA (US)

(72) Inventors: John P. Maneira, Alpharetta, GA (US); Krasimir G. Chobadzhiev, Alpharetta, GA (US)

(73) Assignee: CHEMENCE, INC., Alpharetta, GA (US)

(21) Appl. No.: 13/902,301

(22) Filed: May 24, 2013

Related U.S. Application Data
(60) Provisional application No. 61/816,366, filed on Apr. 26, 2013.

(51) Int. Cl. B41M 5/00

(52) U.S. Cl. CPC B41M 5/00
USPC 101/471

(57) ABSTRACT

Solvent-based inks for inkjet printers are prepared by adding UV-absorbers and/or reflectors. These inks, when printed on uncoated or untreated polymeric films which may be either clear or dyed, produce negatives with sufficient opacity to make photopolymer-based flexographic printing plates.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF INVENTION

1. Field of the Invention

This invention is in the field of printing, more specifically in the field of making flexographic printing plates from photopolymers, and still more specifically in controlling the exposure of the photopolymers in an ultraviolet (UV) exposure unit. The invention is also in the field of making image negatives for such exposures, more specifically negatives printed on polymeric film using inkjet printers, more specifically to such negatives printed with solvent-based inks, and still more specifically in making such negatives with optimum opacity. The invention also pertains to establishing and using the proper combinations of such negatives and UV light intensity.

2. Description of the Related Art

Flexographic printing plates may be made from photopolymers cured by exposure to actinic radiation. To create a relief image on the photopolymer layer, a film negative is placed between the source of radiation, typically ultraviolet (UV) light, and the photopolymer layer. In the remainder of this description and the claims, the word “light” refers to any actinic radiation containing a range of wavelengths capable of causing photoreactive substances such as, but not limited to, photopolymers, to cure. This light includes UV but may include actinic radiation of other wavelengths without limitation unless claimed otherwise.

The relief is created where light passes through the clear areas of the negative. To produce the relief, the photopolymer covered by the dark areas of the negative must be completely shielded from the light. If any degree of polymerization occurs in the covered areas, the photopolymer cannot be removed successfully by washing or scrubbing, and the plate is wasted. One method of making detailed negatives for exposure of photopolymers in a flexo printing plate exposure unit uses an inkjet printer to print a UV-blocking ink onto a clear plastic, e.g., polyester film. At present, only water-based inks are sufficiently opaque. To use water-based inkjet inks, the surface of the film material must be receptive to, or made to be receptive to, water-based inks; that is, the image must adhere to the plastic and dry quickly without migrating so as to preserve detail. The plastic material may be made inkjet-receptive by coating it with, e.g., a micro-porous coating or a coating of inkjet-receptive polymer, or the material may be treated in some other manner such as acid etching, etc. to produce a surface that allows the ink to adhere to the film and dry quickly without migrating. An untreated plastic film may alternatively be printed with an inkjet ink directly so long as the ink and the plastic are mutually compatible. Untreated films are about one-tenth the cost of films treated for use with aqueous inks. Solvent-based inks also have the advantage of being printable at roughly three times the speed of aqueous inks, but at present such inks cannot be used to make flexo plates because they do not create black images which are sufficiently opaque to prevent partial (therefore unacceptable) curing of the photopolymer under the imaged areas. A need exists for solvent-based inks that will either by themselves, or in combination with a filter, such as a dyed film, prevent UV radiation in the applicable wavelength range from penetrating the imaged areas to cause unwanted polymerization.

### BRIEF DESCRIPTION OF THE INVENTION

The instant invention consists of embodiments of solvent-based inks containing combinations of additives that either alone or together with filters such as dyed films yield image opacities suitable for making photopolymer-based flexo plates.

### BRIEF DESCRIPTION OF THE DRAWINGS

Not applicable.

### DETAILED DESCRIPTION OF THE INVENTION

The instant invention enables untreated polymeric films (e.g., polyester) to be used for photopolymer flexo plate making by augmenting the ability of solvent-based inkjet inks to block UV radiation. This is accomplished by adding either brightening compounds or light absorbing or reflecting compounds (or combinations of these) to the ink, and, if necessary, increasing light absorption by either adding dye to the negative film itself, coating the film with a layer of light filtering material, or applying one or more light filtering sheets to one or both sides of the film.

The light absorbing compounds behave like dyes or pigments, while the brighteners work by reflecting incident radiation away from the negative during exposure of the plate. Optical brighteners create brilliance by absorbing UV light, modifying the wavelength of the light and then emitting the light by fluorescence, typically in a visible wavelength. In this instance the benefit is the UV light absorption by the fluorescent material preventing it from penetrating the film and/or transforming the UV into wavelengths that do not cure the photopolymer.

Table I below summarizes the results of experiments adding either brighteners or absorbers to solvent-based inkjet ink and measuring the transmission of UV light from two different UV light sources used to make flexo plates.

TABLE I
UV MASK for Solvent BLUE DYE - 0.5% (5000 ppm) Addition (Jan. 24, 2013)

| | | Light Source: | | | | | |
|---|---|---|---|---|---|---|---|
| | | UVITRON* | | | IDEAL** | | |
| | | UV-Transparency | | | UV-Transparency | | |
| | | Light Intensity: | | | Light Intensity: | | |
| | Sample | mW/cm² | % Transmission | % Decrease | mW/cm² | % Transmission | % Decrease |
| 1. | Empty | 2.53 | | | 1.281 | | |
| 2. | 2-Glass | 2.17 | 100 | 0 | 0.988 | 100 | 0 |
| | Slides | | | | | | |
| 3. | Blue Dye - | 1.011 | 46.6 | baseline | 0.326 | 33.0 | baseline |
| | Control | | | | | | |
| 4. | Tinuvin P - | 0.913 | 42.1 | 4.5 | 0.298 | 30.2 | 2.8 |
| | 5000 ppm | | | | | | |
| 5. | Tinuvin 328 - | 0.467 | 21.5 | 25.1 | 0.135 | 13.7 | 19.3 |
| | 5000 ppm | | | | | | |
| 6. | Tinuvin 5151 - | 0.505 | 23.3 | 23.3 | 0.233 | 23.6 | 9.4 |
| | 5000 ppm | | | | | | |
| 7. | UV-Bright. | 0.47 | 21.7 | 24.9 | 0.0648 | 6.6 | 26.4 |
| | 4061 - | | | | | | |
| | 5000 ppm | | | | | | |
| 8. | UV-Bright. | 0.397 | 18.3 | 28.3 | 0.091 | 9.2 | 23.8 |
| | 4059 - | | | | | | |
| | 5000 ppm | | | | | | |
| 9. | Prophetic | 0.360 | 16.6 | 30.0 | 0.030 | 3.0 | 30.0 |
| | Result | | | | | | |

*Intelli-Ray 400 Exposure Unit
**1200 Stamp Exposure Unit

Two different light sources were used in these experiments, the Uvitron emitting almost double the light intensity of the Ideal unit. (See row 1). Provided a sufficient amount of light is blocked by the dark areas of the negative, the unfiltered intensity of the source only affects the exposure time. The choice of source is therefore determined principally by its cost of operation and useful life.

The solvent-based ink used in these experiments was a UV mask blue dye at 5000 ppm. The ink was applied between two glass slides, which supported the ink layer. Row 2 gives the light absorption results of the two glass slides without ink to simulate clear film and the associated small amount of UV absorption. As shown in row 3, this ink layer blocked only about one-half to two-thirds of the UV light passing through the glass in the applicable curing wavelength range of 240 to 360 nanometers. This is represented by the % transmission figures of 46.6% and 33.0% for the two light sources, respectively. Equivalent light filtration results can be obtained not only by printing an even UV mask dye or pigment coating on the film but also by adding dye or pigment to the film itself during manufacture, or by covering the film on either side with a dyed or pigmented light filter sheet. In the claims, these effects will be referred to in common as “filtering laminate,” even if the “laminate” is merely a dyed polyester sheet printed with solvent-based ink.

Rows 4-6 show the results of adding Tinuvin® light stabilizers (UV absorbers) to the inkjet negative imaging ink. Rows 7-9 show the results of adding UV-Bright brighteners (UV absorbing and fluorescent reflecting compounds) to the inkjet negative imaging ink.

The amounts of UV brighteners and absorbers added to the ink in these experiments did not have any visible effect on the physical attributes of solvent ink, and because the amounts added were less than 1%, it is reasonable to expect that the inks prepared to generate the experimental and prophetic results listed below will run satisfactorily on an inkjet printer.

The brighteners (rows 7-9) seemed to have the greatest impact on UV blocking. Based on successful opacity levels used in the production processes, a goal was set for these experiments to produce an ink with about 30 percentage points greater blockage of light than that of the row 3-“baseline” ink alone. While this % decrease was not achieved in the experiments, the 28.3% decrease using the UV-Bright 4059 brightener is very close. A prophetic result is generated and shown on row 9 of Table I by assuming that a 30% decrease could be achieved and calculating from it the corresponding overall light intensities corresponding to it, namely, 0.360 and 0.030 mW/cm², respectively (all underlined and bold in the table). However, this table does not specify other particular combinations of filtering, absorbers, and brighteners could achieve successful results. A combination of both UV absorbers and brighteners will block a wider spectrum of UV Light.

Table II does this with the data from the Uvitron exposure unit by calculating the light intensities that are estimated from linear combinations of additional filtering, absorbers, and brighteners.

TABLE II
UVITRON

| | | | | | Total Light |
|---|---|---|---|---|---|
| | | Light | Fraction of | Product of | Intensity |
| | | Intensity | UV | UV | Penetration |
| | Sample | mW/cm² | Penetration | Penetration | mW/cm² |
| 1. | Empty | 2.530 | | | |
| 2. | 2-Glass | 2.170 | | | |
| | Slides | | | | |
| 3. | Blue Dye - | 1.011 | 0.466 | 0.466 | 1.011 |
| | Control | | | | |
| | “filtering | | | | |
| | laminate” | | | | |
| 4. | Tinuvin P - | 0.913 | | | |
| | 5000 ppm | | | | |
| 5. | Tinuvin | 0.467 | 0.215 | 0.100 | 0.218 |
| | 328 - | | | | |
| | 5000 ppm | | | | |
| 6. | Tinuvin | 0.505 | | | |
| | 5151 - | | | | |
| | 5000 ppm | | | | |
| 7. | UV-Bright. | 0.470 | | | |
| | 4061 - | | | | |
| | 5000 ppm | | | | |
| 8. | UV-Bright. | 0.397 | 0.183 | 0.085 | 0.185 |
| | 4059 - | | | | |
| | 5000 ppm | | | | |
| 9. | Prophetic | 0.360 | NA | NA | NA |

Here, as in Table I, the measured UV light intensities are shown in the second column, rows 1-8. Note that, as also shown in Table I, the 30% light decrease goal corresponds to a prophetic final intensity of 0.360 mW/cm².

The Total Light Intensity Penetration for combinations of the dye control “filtering laminate” and either the UV absorbers (rows 4-6) or the brighteners (rows 7-8) shown in the rightmost column was calculated as follows. First, the Fraction of UV Penetration for rows 3, 5 and 8 was calculated by dividing the Light Intensity value in the second column of rows 3, 5 and 8 by the control Light Intensity of row 3, second column. The combined fractional UV penetration of the combination of the Control “filtering laminate” and the absorber in row 5 is given by the product of the Fraction of UV Penetration in row 5 (0.215) and row 3 (0.466). The result appears in the Product of UV Penetration column in row 5 (0.100). The Total Light Intensity Penetration through both the filtering laminate and the absorber in the ink is therefore that fraction (0.100) times the control intensity (second column, row 3) namely, 0.218 milliwatt per square centimeter. The Total Light Intensity Penetration is not shown for rows 4 and 6 because they were higher than 0.218. The same algorithm was followed to calculate the lowest Total Light Intensity Penetration through the combination of filtering laminate and brightener, which turned out to be 0.185 mW/cm². While the total light intensity penetration of the blue dye control filtering laminate by itself is too high to reach the goal by a large margin, the product of its light reduction and that of Tinuvin® 328 (row 5) produces the combined light intensity of 0.218 mW/cm², below that necessary to meet the goal. The same is true of the combination of the blue dye control and UV-Bright 4059 (0.185 mW/cm²). These compare favorably to the combined prophetic measured light intensity of 0.360.

Turning now to Table III, the prophetic results of working with the Ideal light source are calculated.

TABLE III
IDEAL

| | | | | | Total Light |
|---|---|---|---|---|---|
| | | Light | Fraction of | Product of | Intensity |
| | | Intensity | UV | UV | Penetration |
| | Sample | mW/cm² | Penetration | Penetration | mW/cm² |
| 1. | Empty | 1.281 | | | |
| 2. | 2-Glass | 0.988 | | | |
| | Slides | | | | |
| 3. | Blue Dye - | 0.220 | 0.223 | 0.223 | 0.220 |
| | Control | | | | |
| | “filtering | | | | |
| | laminate” | | | | |
| 4. | Tinuvin P - | 0.298 | | | |
| | 5000 ppm | | | | |
| 5. | Tinuvin | 0.135 | 0.137 | 0.030 | 0.030 |
| | 328 - 5000 | | | | |
| | ppm | | | | |
| 6. | Tinuvin | 0.233 | | | |
| | 5151 - | | | | |
| | 5000 ppm | | | | |
| 7. | UV-Bright. | 0.065 | 0.066 | 0.015 | 0.014 |
| | 4061 - | | | | |
| | 5000 ppm | | | | |
| 8. | UV-Bright. | 0.091 | | | |
| | 4059 - | | | | |
| | 5000 ppm | | | | |
| 9. | Prophetic | 0.030 | 0.030 | 0.007 | 0.007 |

Note that in this case, if the concentration of dye in the blue dye control “filtering laminate” were increased to cause its light output to drop from 0.326 mW/cm² to 0.220 mW/cm², combining that with Tinuvin® 328 would equal the prophetic result of 0.030. Adding UV-Bright 4061 to the ink as well would produce a light intensity underneath the negative images of 0.014 mW/cm². It is reasonable to predict that if the concentration of dye in the control were changed from 5000 ppm to a higher level (perhaps in proportion to the additional amount of light needed to be absorbed) the output UV light intensity could be reduced to 0.220 mW/cm² and produce the prophetic result.

The instant invention and the experiments were directed at producing solvent-based inkjet negatives, or laminates containing such negatives, for the purpose of controlling UV exposure in flexo plate manufacture. The claimed matter also applies to other apparatuses and processes in which it would be advantageous to control light penetration, or exposure of other photoreactive materials, using combinations of filters and solvent ink compatible films.

1. A solvent-based inkjet negative, comprising:
a polymeric film compatible with solvent-based ink and having inked areas;
the polymeric film being thin in one dimension, broad in the two other dimensions, a surface in
the two other dimensions to be illuminated by a light having an initial intensity;
a first combination of light filtering substances uniformly spread in the other two dimensions;
the ink comprising a second combination of light filtering substances;
the first and second combinations of light filtering substances preventing polymerization of photopolymers opposite to the surface to be illuminated when light is shone on the surface to be illuminated.

2. The negative of claim 1, in which:
said first combination of light filtering substances is taken from the list of:
a. none;
b. at least one layer of fluorescent substance;
c. at least one layer of light-reflecting substance;
d. at least one layer of light absorbing substance;
e. at least one fluorescent substance dispersed within the film;
f. at least one light-reflecting substance dispersed within the film;
g. at least one light absorbing substance dispersed within the film; and
h. any combination of b. through g. above.

3. The negative of claim 1, in which:
said second combination of light filtering substances is taken from the list of:
a. none;
b. a fluorescent substance;
c. a light-reflecting substance;
d. a light absorbing substance; and
e. any combination of b. through d. above.

4. The negative of claim 1, in which:
said first combination of light filtering substances is taken from the list of:
a. none;
b. at least one layer of fluorescent substance;
c. at least one layer of light-reflecting substance;
d. at least one layer of light absorbing substance;
e. at least one fluorescent substance dispersed within the film;
f. at least one light-reflecting substance dispersed within the film;
g. at least one light absorbing substance dispersed within the film; and
h. any combination of b. through g. above; and
said second combination of light filtering substances is taken from the list of:
i. none;
j. a fluorescent substance;
k. a light-reflecting substance;
l. a light absorbing substance; and
m. any combination of j. through l. above.

5. The negative of claim 1, in which:
said first combination of light filtering substances reduces the initial intensity by at least 50%; and
said second combination of light filtering substances reduces the initial intensity by at least an additional 30 percentage points.

6. A light filtering laminate, comprising:
at least one layer comprising a first substance taken from the list of:
a. at least one substance which absorbs light of a specified wavelength range and fluoresces in a wavelength other than the specified wavelength range;
b. at least one substance that reflects light of a specified wavelength range away from the layer of photoreactive material;
c. at least one substance that absorbs light of a specified wavelength range and converts it to heat; and
d. any combination of a. through c. above; and
at least one layer printed with a negative image comprising a solvent-based ink,
the ink comprising a second substance taken from the list of:
a. at least one substance which absorbs light of a specified wavelength range and fluoresces in a wavelength other than the specified wavelength range;
b. at least one substance that reflects light of a specified wavelength range away from the photoreactive material;
c. at least one substance that absorbs light of a specified wavelength range and converts it to heat; and
d. any combination of a. through c. above.

7. The light filtering laminate of claim 6, wherein:
said at least one layer comprising a first substance and said at least one layer printed with a negative image are one and the same.

8. The light filtering laminate of claim 7, in which:
said specified wavelength range is about 200 to 400 nanometers.

9. The light filtering laminate of claim 7, in which:
said specified wavelength range is about 240 to 360 nanometers.

10. The light filtering laminate of claim 6, in which:
the unprinted areas in said light filtering laminate reduce the intensity of light impinging on said filtering laminate by at least 50%; and
said ink reduces the light passing through the unprinted areas by at least an additional 30 percentage points.

11. A method for making a light filtering laminate, comprising the steps of:
a. adding at least one light filtering substance to at least one layer of light transmitting material;
b. adding at least one light filtering substance to a solvent-based inkjet printing ink;
c. using the ink from step b. to print a negative image on at least one layer of film compatible with solvent-based inkjet ink; and
d. superimposing any resulting plurality of layers.

12. The method of claim 11, in which:
said light filtering substance is taken from the list of:
a. at least one substance which absorbs light of a specified wavelength range and fluoresces in a wavelength other than a specified wavelength range;
b. at least one substance that reflects light of a specified wavelength range away from the photo reactive material; and
c. at least one substance that absorbs light of a specified wavelength range and converts it to heat.

13. The method of claim 12, in which:
said specified wavelength range is about 200 to 400 nanometers.

14. The method of claim 12, in which:
said specified wavelength range is about 240 to 360 nanometers.

15. The method of claim 11, in which:
the unprinted areas in said light filtering laminate reduce the intensity of light impinging on said light filtering laminate by at least 50%; and
said ink further reduces the intensity of light passing through the laminate by at least an additional 30 percentage points.
